(19) United States
(12) Patent Application Publication
(10) Pub. No.: US 2002/0141707 A1
(43) Pub. Date: Oct. 3, 2002

(54) Small-formed optical module with optical waveguide

(76) Inventor: Ki Chul Shin, Gunpo-city (KR)

Correspondence Address: ROBERTS ABOKHAIR & MARDULA, SUITE 1000, 11800 SUNRISE VALLEY DRIVE, RESTON, VA, 20191, US

(21) Appl. No.: 10/107,855

(22) Filed: Mar. 27, 2002

(30) Foreign Application Priority Data
Mar. 28, 2001 (KR) 2001-16114
Mar. 28, 2001 (KR) 2001-16117
Mar. 22, 2002 (KR) 2002-15697

(51) Int. Cl. G02B 6/42

(52) U.S. Cl. 385/92; 385/93

(57) ABSTRACT

An optical module with an optical waveguide formed on the front of a luminous element. The optical waveguide serves to adjust the size of an input terminal and an output terminal, thereby more effectively concentrating the light generated from the luminous element on an optical fiber. The optical module of the present invention improves photo coupling efficiency and easily implements the alignment of the optical fiber. Further, the passive alignment between the package and the substrate is achieved by matching the protrusion with the depression without operating the luminous element or the light receiving element. The optical module of the present invention is manufactured after the passive alignment of the package and the substrate, thereby simplifying the manufacturing process and shortening the alignment time.

### RELATIONSHIP TO PRIOR APPLICATIONS

This application claims the benefit under 35 U.S.C. §119 of Korean Patent Application No. 2001-16114, filed Mar. 28, 2001, Korean Patent Application No. 2001-16117, filed Mar. 28, 2001, and Korean Patent Application No. 2002-15697, filed Mar. 22, 2002.

### FIELD OF THE INVENTION

The present invention relates to an optical module, and more particularly to an optical module with an optical waveguide formed on the front of a luminous element. The optical waveguide serves to adjust the size of an input terminal and an output terminal, thereby more effectively concentrating the light generated from the luminous element on an optical fiber.

### BACKGROUND OF THE INVENTION

As well known to those skilled in the art, in order to advance the information age, an optical module for transmitting a large quantity of data has been recently required. Such an optical module demands not only excellent self-characteristics but also reliability so as to maintain the characteristics for a long time. In order to promote the spread of this optical module to implement a FTTH (fiber to the home) system, the optical module should be offered at a moderate price. Particularly, as capacity of the optical transmission system has been increased, attempts to reduce the size of the optical module installed on the optical transmission system and to increase the number of the installable optical modules on the unit area of the optical transmission system are now under way.

An active element of the optical module serves to change electric signals into optical signals or optical signals into electric signals. Generally, methods of aligning the active element of the optical module (for example, such as a laser diode and a photo diode) and an optical fiber are divided into two, i.e., an active alignment method and a passive alignment method.

In the active alignment method, a location for maximally outputting an optical power is searched by operating a specific facility with fine resolution of less than μm unit, and then the active elements and the optical fibers are aligned on this optimum location. Therefore, the active alignment method requires many long hours, thereby hindering mass-production of the optical module. Further, the active alignment method requires additional equipment such as the aforementioned facility, thereby increasing the production cost and lowering a competitiveness of the optical module.

On the other hand, in the passive alignment method, the active elements and the optical fibers are exactly aligned without current supply. The maximum power output is obtained by exactly aligning the active element prior to a step of aligning the optical fiber.

As shown in FIG. 1, a conventional optical communication module concentrates the light generated from a luminous element on an optical fiber by aligning the optical fiber on the front of the luminous element or by interposing optical components such as a lens between the luminous element and the optical fiber. Therefore, it is difficult to adjust the beam to a user's desired size prior to the optical fiber. Therefore, if the focus is well set to reduce the size of the beam, the optical module is manufactured by the active alignment method using the high-priced facility with fine resolution. Therefore, the production time of the optical module is lengthened, thereby increasing the production cost and reducing the productivity.

Further, if the beam size of the light generated from the luminous element is not effectively adjusted, since the light cannot easily be concentrated on the optical fiber, it is difficult to produce a high-powered optical module.

Therefore, in order to improve photo-coupling efficiency and easily implement the alignment of the optical fiber, the beam size needs to be properly adjusted prior to the optical fiber.

### SUMMARY OF THE INVENTION

Therefore, the present invention has been made in view of the above problems, and it is an object of the present invention to provide an optical module, which improves photo-coupling efficiency and easily implements the alignment of the optical fiber.

Another object of the present invention is to provide an optical module, which easily achieves the passive alignment between a package and a substrate without operating any active element.

In accordance with one aspect of the present invention, the above and other objects can be accomplished by the provision of an optical transmitting module comprising a substrate with active elements attached thereto, and a package comprising a light collecting means for transmitting the light generated from a luminous element to an optical fiber and pins for electrically connecting the package to an external device. Herein, an optical waveguide for adjusting the divergence angle of the light generated from the luminous element is formed on the substrate at the front area of the luminous element.

Preferably, a protrusion with a designated shape may be formed on one between the bottom surface of the substrate and the bottom surface of a cavity of the package (i.e., an upper surface of a bottom wall of a cavity of said package), and a depression to be matched with the protrusion may be formed on the other. Thus, the passive alignment between the package and the substrate is achieved by matching the protrusion with the depression.

Further, preferably, the optical transmitting module of the present invention may be a multi-optical transmitting module comprising at least two optical transmitting modules.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional optical module, respectively;

FIG. 2 is a cross-sectional view of an optical transmitting module in accordance with an embodiment of the present invention;

FIGS. 3a, 3b, and 3c are a top view, a perspective view, and a bottom view of a transmitting substrate of the optical transmitting module of FIG. 2, the transmitting substrate with active elements and an optical waveguide attached thereto;

FIG. 4 is an exploded perspective view of the optical transmitting module of FIG. 2; and

FIG. 5 is an exploded perspective view of an optical transceiver module in accordance with another embodiment of the present invention.

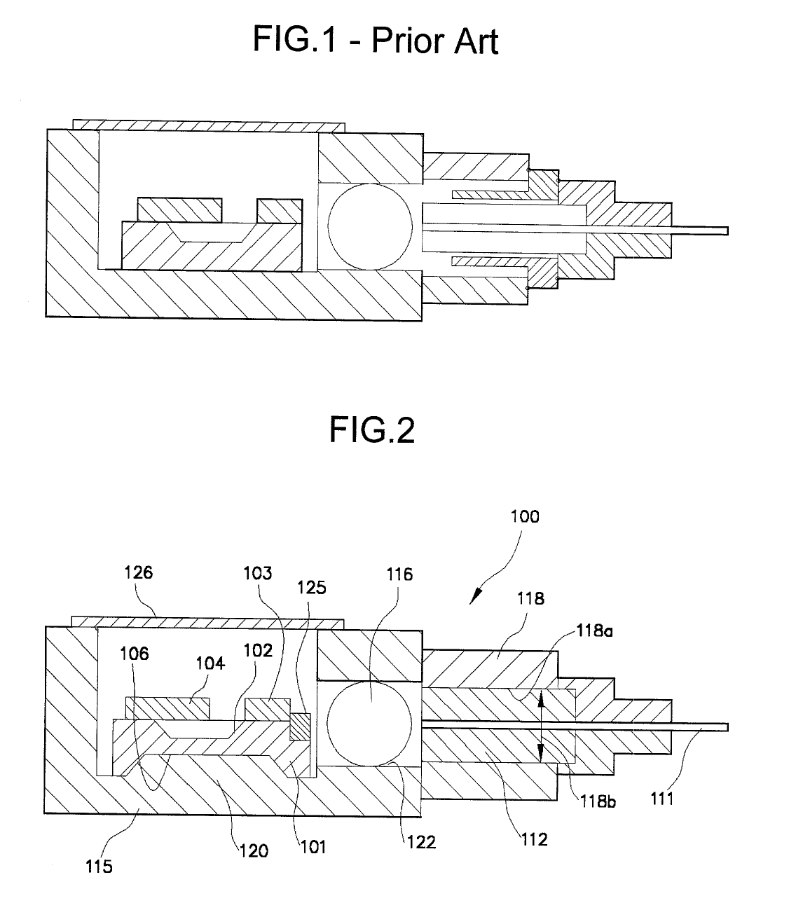

### DESCRIPTION OF THE PREFERRED EMBODIMENTS

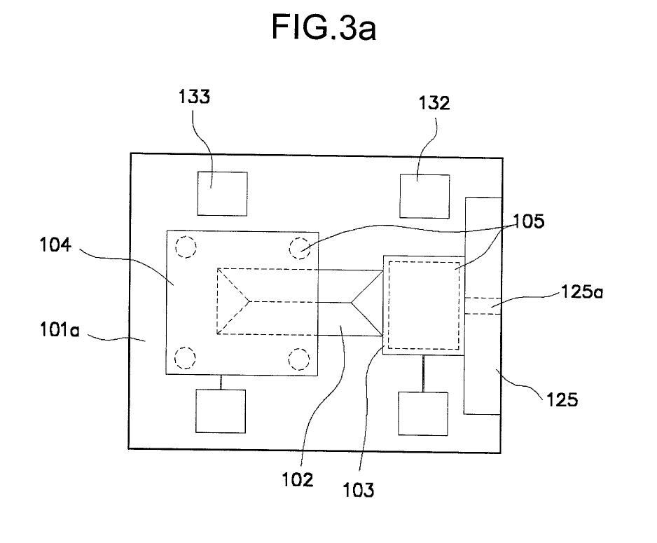

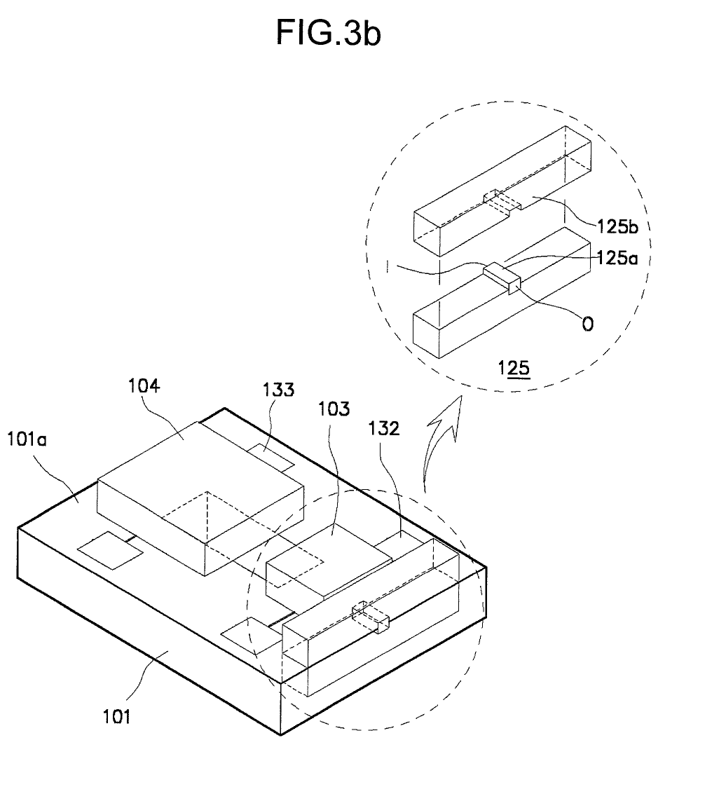

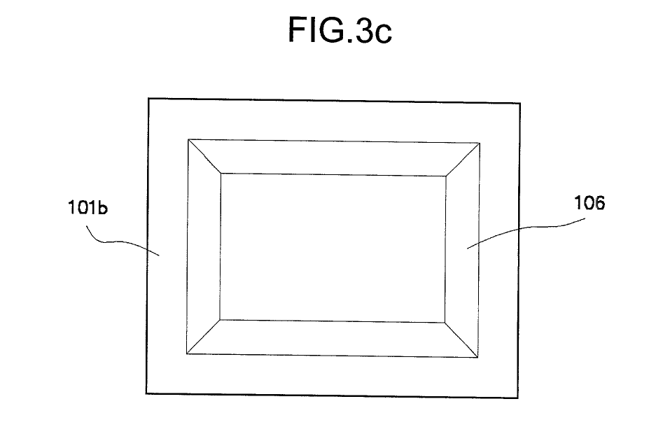

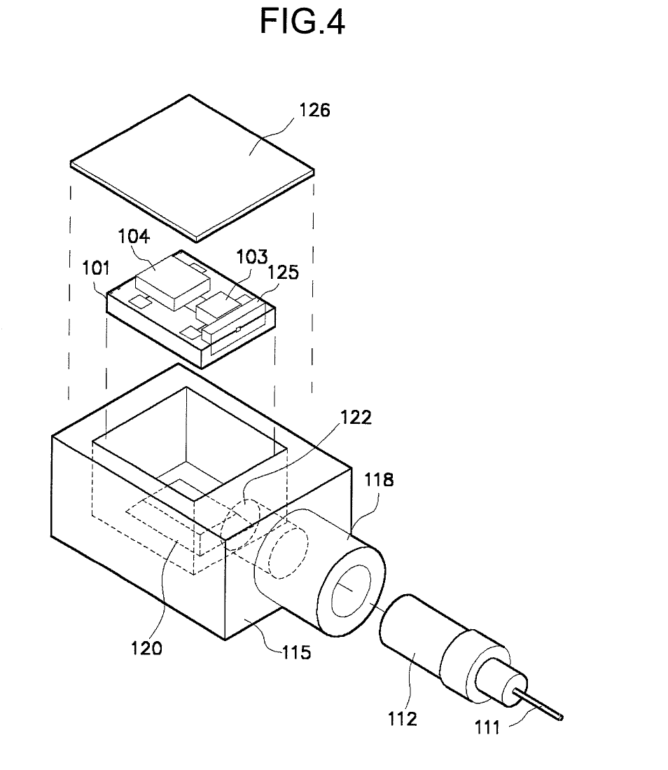

FIG. 2 is a cross-sectional view of an optical transmitting module in accordance with an embodiment of the present invention. FIGS. 3a, 3b, and 3c are a top view, a perspective view, and a bottom view of a transmitting substrate of the optical transmitting module of FIG. 2, the transmitting substrate with active elements and an optical waveguide attached thereto. FIG. 4 is an exploded perspective view of the optical transmitting module of FIG. 2.

With reference to FIGS. 2 to 4, the optical transmitting module 100 in accordance with an embodiment of the present invention is described hereinafter.

The optical transmission module 100 includes an integrated module package 115 with a light collecting means formed on the front surface, a substrate 101 attached to the bottom surface of a cavity of the package 115 (i.e., the upper surface of a bottom wall of a cavity of said package), and a luminous element 103, a light receiving element 104, and an optical waveguide 125 attached to the upper surface of the substrate 101. The light receiving element 104 acts as a sensor for controlling the optical power output of the luminous element 103.

The light collecting means includes a lens insertion hole 122 and a transmitting lens 116 formed on the front surface of the package 115, and a transmitting guide pipe 118 connected to the lens insertion hole 122 and provided with a hollow 118a in which a transmitting ferrule 112 is inserted.

The position of the light collecting means is not limited to the front surface of the package 115. If the light emitting surface of the luminous element 103 is vertical to the ground surface, the light collecting means is formed on the upper surface of the package 115. Therefore, the position of the light collecting means is changeable by the position of the light emitting surface of the luminous element 103.

The transmitting lens 116 usually employs a ball lens and is installed on a precalculated area within the lens insertion hole 122 so that the light from the luminous element 103 is concentrated on a core of an optical fiber 111 within the transmitting ferrule 112.

The transmitting guide pipe 118 includes the hollow 118a, in which the transmitting ferrule 112 provided with the optical fiber 111 is inserted. The shape of the transmitting ferrule 112 is not limited. Preferably, the transmission ferrule 112 is cylindrical in shape. In this case, by allowing the internal diameter 118b of the hollow 118a to be substantially as much as the external diameter of the transmitting ferrule 112, even though the cylinder-shaped transmitting ferrule 112 is inserted in any direction into the hollow 118a, the light is concentrated exactly on the core of the optical fiber 111.

The package 115 is made of ceramic, metal including alloy, or its equivalents, but is not limited thereto. Preferably, a protrusion 120 with a designated shape for fixing the substrate 101 is formed on the bottom surface of the cavity of the package 115, and an opening for introducing the substrate 101 and a cover 126 are formed on the upper surface of the package 115. Herein, the position of the opening is not limited thereto, but changeable by the position of the light collecting means. Even though not shown in these drawings, pins for electrically connecting the elements within the package to an external circuit board (not shown) may be introduced. The structure of the pin is well known to those skilled in the art, thus its detailed description is omitted.

The protrusion 120 formed on the bottom surface of the cavity of the package 115 serves to fix the substrate 101, of which height is adjusted so that the optical waveguide 125 formed on the optimum position projects the light on the transmission lens 116. The shape of the protrusion 120 is also not limited. Therefore, the shape of the protrusion 120 may include a V-groove or a MESA structure with an inclined sidewall at a designated angle.

Preferably, the substrate 101 is a semiconductor substrate, for example, a silicon substrate. The luminous element 103 is attached by a solder 105 to a front area of the upper surface of the substrate 101 of which height is adjusted so that the optimum light is projected on the transmitting lens 116. The monitoring light receiving element 104 for sensing the light irradiated from the back surface of the luminous element 103 is attached by the solder 105 to a rear area of the upper surface of the substrate 101. A reflection groove 102 with a designated shape is formed below the light receiving element 104. The reflection groove 102 reflects the light irradiated from the back surface of the luminous element 103 and projects the reflected light on the surface of the light receiving element 104. Preferably, the reflection groove 102 includes a V-shaped groove with a designated width and depth, but is not limited thereto. The width and the depth of the reflection groove 102 are determined by orientation of crystal of the substrate 101.

The luminous element 103 and the light receiving element 104 are not limited to each of the above-described positions. For example, the luminous element may be mounted on the monitoring light receiving element. With this configuration, a designated amount of the light generated from the luminous element is reflected and the reflected light is projected on the upper surface of the light receiving element.

In order to electrically connect the luminous element 103 and the light receiving element 104 to pins (not shown) for electrically connecting the elements 103, 104 to an external device, contact points 132, 133 and patterns are formed on a designated location of the substrate 101. The pins electrically connect the inner active elements to an external device and are usually a form of leads of the lead frame.

A laser diode is generally used as the luminous element 103. Preferably, the bottom surface of the laser diode has an uneven structure (including prominences and depressions) with the height and size, which are pre-determined by the orientation by the crystallographic characteristic of single crystal. In this case, a corresponding uneven structure with the same pre-determined height and size is formed on a designated area of the substrate 101. Thereby, the luminous element 103 is exactly received on the substrate 101 without an additional alignment step.

The optical waveguide 125 is formed on the front of the luminous element 103. The optical waveguide 125 controls the divergence angle of the light generated from the luminous element 103. Herein, the optical waveguide 125 may use a known finished product or may be manufactured by a known technique. The optical waveguide 125 includes a core 125a and a cladding body 125b. The sizes of an input terminal I and an output terminal 0 of the optical waveguide 125 are adjustable so that the light passing through the optical waveguide 125 substantially has the same size of that of the core 125a. Thereby, most of the light generated from the luminous element 103 can be transmitted to the optical fiber. Then, a high-powered optical module can be produced.

According to adjusting the widths and the lengths of the core 125a and the cladding body 125b in the production step of the optical waveguide 125, the light passing through the optical waveguide 125 may be formed as a beam with a large width or a beam with a small width on the front of the optical fiber. In case the light passing through the optical waveguide 125 is formed as a Gaussian beam, alignment error in the passive alignment can be usefully extended.

The size of the beam outputted from the optical waveguide 125 can be adjusted by the length L of the optical waveguide 125, the width and length of the core formed on the input and out terminals I, O or refractivity of the optical waveguide 125.

A photo diode is generally used as the monitoring light receiving element 104. The light receiving element 104 controls the light irradiated by the luminous element 103 by sensing the intensity of the light projected on the surface of the light receiving element 104. Herein, a control circuit of the light receiving element 104 may be formed on an external electronic circuit board (not shown). Since this control circuit is apparent to those skilled in the art, its detailed description is omitted.

A depression 106 with a predetermined shape and size to be matched with the protrusion 120 formed on the bottom surface of the cavity of the package 115 is formed on the bottom surface 101b of the substrate 101. The depression 106 may be formed by any conventional etching method.

The passive alignment between the package 115 and the substrate 101 is simply achieved by matching the depression 106 of the substrate 101 with the protrusion 120 of the bottom surface of the package 115. That is, since the final position of the luminous element 103 is pre-determined so that the optical axis is exactly located on the core of the optical fiver 111 within the ferrule 112, the passive alignment can be simply completed by only a subsequent step of inserting and fixing the transmitting ferrule 112 into the package 115.

The optical transmitting module of the present invention may be a multi-optical transmitting module provided with at least two parallel-connected optical transmitting modules.

Hereinafter, a method of manufacturing the optical transmitting module of this embodiment of the present invention is described. However, an electrical connection step, such as a wire bonding, is apparent to those skilled in the art, thus its detailed description is omitted.

The integrated module package 115 is mounted on a stage (not shown). The silicon substrate 101 with the laser diode 103, the monitoring photo diode 104, and the optical waveguide 125 attached thereto is picked up. The picked-up silicon substrate 101 is moved into the cavity of the package 115, and then is received on an exact area of the silicon substrate 101 by matching the rectangular-shaped depression 106 with an inclined sidewall and an even bottom surface with the protrusion 120 with a shape corresponding to the depression 106. The upper surface of the protrusion 120 is coated with a solder with a designated melting point.

The stage is heated and the solders (not shown) coated on the protrusions 120, 121 are molten. Thereby, the transmitting silicon substrate 101 is attached to an exact area of the integrated module package 115.

After attaching the transmitting silicon substrate 101 to the integrated module package 115, the cover 126 is fixed to the upper surface of the integrated module package 115 by an electric welding under nitrogen atmosphere.

Then, each of the transmitting ferrule 112 including the transmitting optical fiber 111 is inserted into the hollows 118 of the transmitting guide pipe 118. Then, the transmitting ferrule 112 is fixed to the transmitting guide pipe 118 by a laser welding. Thereby, the optical transmitting module 100 is manufactured.

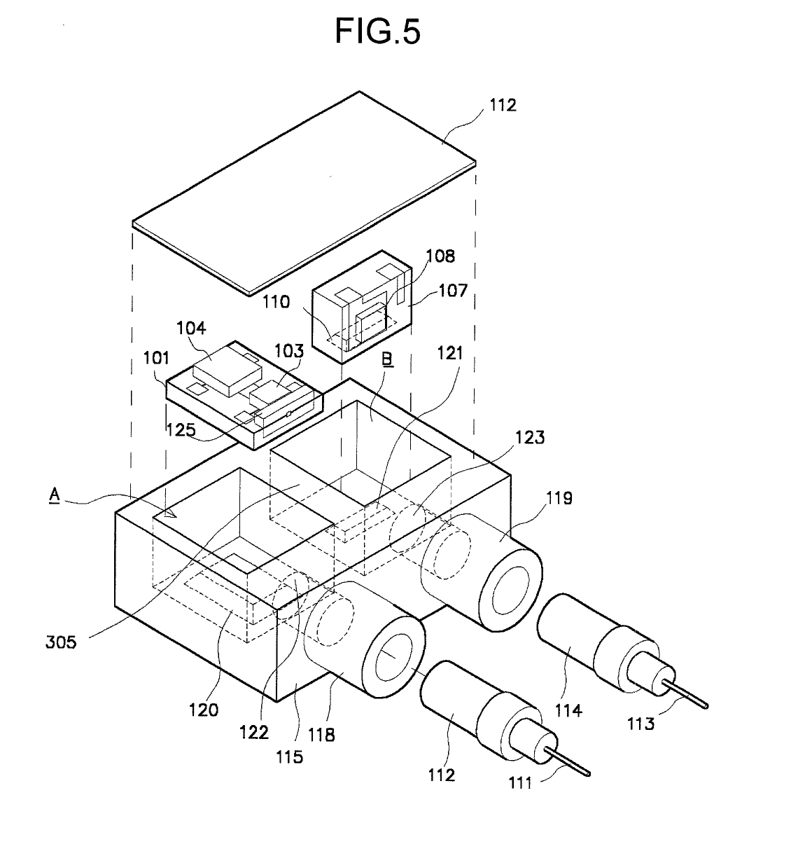

FIG. 5 is an exploded perspective view of an optical transceiver module in accordance with another embodiment of the present invention.

With reference to FIG. 5, the optical transceiver module in accordance with yet another embodiment of the present invention is described hereinafter.

The optical transceiver module is formed by integrating the optical transmitting module and the optical receiving module.

As shown in FIG. 5, a package of the optical transceiver module 300 includes the transmitting and receiving guide pipes 118, 119 connected to the lens insertion holes 122, 123 and formed on the front surface of the package, and the protrusions 120, 121 with a designated shape formed on the bottom surface of cavities A, B, which are separated by a diaphragm 305. The depressions 106, 110 with a predetermined shape and size to be matched with the protrusions 120, 121 are formed on the bottom surfaces of the transmitting substrate 101 with the active elements and the optical waveguide and the receiving substrate 107 with the light receiving element. Thereby, the bottom surfaces of the substrates are exactly aligned on the cavities of the package by the matching of the depressions 106, 110 of the substrates with the protrusions 120, 121 of the packages, respectively.

The openings for introducing the substrates 101, 107 and the cover 126 are formed on the upper surface of the packages.

The aforementioned transceiver module is electrically connected to the transceiver electronic circuit board (not shown) for operating and controlling the active elements, which are installed on the transmitting module and the receiving module.

In accordance with the preferred embodiments of the present invention, the divergence angle of the light is adjustable, thereby maximally concentrating the light on the optical fiber and maximizing power output efficiency. The alignment error can be shortened by enlarging the size of the beam. Moreover, the present invention is capable of easily fulfilling the passive alignment between the package and the substrate without operating the luminous element, thereby simplifying the manufacturing process and shortening the alignment time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical transmitting module comprising:
a substrate with active elements, including a luminous element, attached thereto; and
a package comprising a light collecting means for transmitting light generated from the luminous element to an optical fiber and pins for electrically connecting said package to an external device,
wherein an optical waveguide for adjusting a divergence angle of the light generated from the luminous element is formed on the substrate at the front area of the luminous element.

2. The optical transmitting module as set forth in claim 1, wherein a protrusion with a designated shape is formed on one of a bottom surface of said substrate and an upper surface of a bottom wall of a cavity of said package, and a depression to be matched with said protrusion is formed on the other, whereby passive alignment between said package and said substrate is achieved by matching the protrusion with the depression.

3. The optical transmitting module as set forth in claim 2, wherein a protrusion of a MESA structure with an inclined sidewall at a designated angle is formed on the upper surface of the bottom wall of the cavity of said package.

4. The optical transmitting module as set forth in claim 1, wherein said package is made of a material selected from the group consisting of ceramic, metal, and equivalents thereof.

5. The optical transmitting module as set forth in claim 1, wherein said light collecting means comprises a guide pipe and a ferrule inserted into the guide pipe, and said ferrule is, when inserted, tightly coupled with said guide pipe by allowing an internal diameter of the guide pipe to be substantially as much as an external diameter of the ferrule.

6. A multi-optical transmitting module comprising at least two optical transmitting modules as claimed in claim 1.

7. An optical transceiver module formed by integrating the optical transmitting module as claimed in claim 1 and an optical receiving module.
